(19) United States
(12) Patent Application Publication
(10) Pub. No.: US 2004/0165678 A1
(43) Pub. Date: Aug. 26, 2004

(54) Method for measuring and compensating gain and phase imbalances in quadrature modulators

(76) Inventor: Zivi Nadiri, Mazkeret Batya (IL)

Correspondence Address: Mark M Friedman, Bill Polkinghorn, Discovery Dispatch, 9003 Florin Way, Upper Marlboro, MD, 20772, US

(21) Appl. No.: 10/479,056

(22) PCT Filed: Aug. 27, 2002
(86) PCT No.: PCT/US02/27192

(51) Int. Cl. H04K 1/02

(52) U.S. Cl. 375/296

(57) ABSTRACT

A simple and efficient method to measure base-band gain and phase imbalance as well as orthogonality phase imbalance in a quadrature (IQ) modulator (12). The method comprises estimating values of modulator gain and phase imbalances (34) while the modulator is operational, by inputting at least one test signal at a base-band frequency 2 fi and computing the imbalances based on the 2 fi term, the computed imbalances then used in normal transmit operation to generate a pre-distortion transformation on the transmit signal to generate an imbalance compensation. The method can be easily expanded to cope with frequency dependent base-band amplitude and phase imbalance. This feature has an advantage when the transmitted signal is a multi-carrier signal, as the compensation can be adapted for each individual carrier.

### FIELD AND BACKGROUND OF THE INVENTION

The present invention relates to measurement and calibration of quadrature modulators as used in transmitters for digital communication. Quadrature modulators (sometimes referred to as IQ modulators), in particular those used in RFIC (Radio Frequency Integrated Circuits) operating at high frequencies in the GHz range, may incur significant gain and phase imbalances in the base-band path, as well as orthogonality phase imbalance in the local oscillator path. The effect of these impairments, generally denoted as gain and phase imbalances (or “IQ” imbalance), is distortion of the transmitted signal, which translates to reduced or even unacceptable performance.

In many cases it is not practical, and sometimes even not feasible, to design and build quadrature modulators with sufficiently low values of gain and phase imbalances. However, if the quadrature modulator gain and phase imbalances can be estimated, there exist known methods to compensate or equivalently pre-distort the transmitted input signal, thus canceling their effect. Typically, the values of gain and phase imbalances are not fixed, and may change as a function of operating conditions, aging, etc., thus requiring a simple and efficient built-in method to perform these measurements and evaluate the compensation terms, on a timely basis, while the quadrature modulator is installed and operational.

### SUMMARY OF THE INVENTION

The method applies a sequence of test signals at the input of the quadrature modulator, with the resulting output coupled to a detector and processed in order to evaluate estimates of modulator gain and phase imbalances. In normal transmit operation these estimates are used to compensate, or equivalently pre-distort, the transmitted signal, and as such to cancel the effects of the gain and phase imbalances on the transmitted signal.

The method proposed herein uses a sequence of test input signals, which, combined with the operation of the detector circuit, provides a simple and accurate evaluation of the modulator imbalance terms. In a preferred embodiment, the test signals are sine waveforms with specific amplitude and phase, resulting in a specific signal at the quadrature modulator output. The quadrature modulator gain and phase imbalances distort this signal as compared with an ideal quadrature modulator. This distortion is equivalent to the generation of additional spectral components, whose frequency, amplitude, and phase are a function of the modulator imbalance values. A detector coupled to the modulator output performs a non-linear operation, which generates intermodulation products between the various spectral components. It is shown below that the amplitude of the 2fᵢ component, where fᵢ is the frequency of the input sine waveform, is proportional to the modulator gain and phase imbalance terms and that by controlling the amplitude and phase of the test signals, it is possible to derive these terms from the amplitude of the 2fᵢ component.

According to the present invention, there is provided a method for calibrating a quadrature modulator having an I input and a Q input for inputting base-band I(t) and Q(t) signals, the modulator used to transmit quadrature modulated signals, comprising: a) estimating in sequence values of modulator gain imbalances and of modulator phase imbalances while the modulator is operational, the estimating including inputting at least one test signal at a base-band frequency fᵢ to the modulator to generate detected output signals having a term at frequency 2fᵢ, first in the gain imbalance estimation, then in the phase imbalance estimation, and computing the gain and phase imbalances based on the 2fᵢ term of the detected output signals, and b) in normal transmit operation, compensating first for the gain and then for the phase imbalances to obtain an essentially ideal quadrature modulated signal, the compensating including inputting a transmission signal to the modulator, and based on the computed gain and phase imbalances, applying a pre-distortion transformation on the input transmission signal.

According to one feature in the method of the present invention, the computing of the gain imbalance is based on an iterative operation that includes modifying the test signals and repeating the measurement of the detected output signal terms at frequency 2fᵢ until reaching a reference value of the detected output signal.

According to another feature in the method of the present invention, the method further includes: for the gain imbalance, inputting in a first step a cosine waveform at the I input, and a zero waveform at the Q input, and in a second step a zero waveform at the I input and the same cosine waveform at the Q input, and, for the phase imbalance, inputting in a first step at the I and Q inputs two sine waveforms of equal amplitude and frequency but shifted by −90°+θ₁ as given by eqn. 17, and, optionally, inputting in a second step two sine waveforms of equal amplitude and frequency but shifted by +90°+θ₂ as given by eqn. 21.

According to yet another feature in the method of the present invention, the computing of the phase imbalances includes computing separately a base-band phase imbalance Δθ and a local oscillator orthogonality phase imbalance Δφ, using the inputting of test signals and an iterative operation that includes modifying the test signals by varying the phases θ₁ and θ₂ and repeating the measurement of the detector output signals until effectively cancelling the signal terms at frequency 2fᵢ.

According to yet another feature in the method of the present invention, the reference value mentioned above is the result of the first measurement of the detected output amplitude at frequency 2fᵢ as generated by a first test signal.

According to yet another feature in the method of the present invention, the inputting of at least one test signal at a base-band frequency fᵢ includes inputting a plurality N of test signals, each at a different base-band frequency fᵢ(N), and the applying of a pre-distortion transformation on the input transmission signal includes applying a frequency-dependent pre-distortion transformation.

### BRIEF DESCRIPTION OF THE DRAWINGS

The invention is herein described, by way of example only, with reference to the accompanying drawings, wherein:

FIG. 1 shows a top level block diagram of the system including a quadrature modulator in which the method of the present invention is applied;

FIG. 2 shows a general block diagram illustrating the main steps of the method;

FIG. 3 shows the signal flow through the quadrature modulator;

FIG. 4 shows a gain imbalance measurement flow diagram;

FIG. 5 shows a phase imbalance measurement flow diagram;

### DESCRIPTION OF THE PREFERRED EMBODIMENTS

Method Overview

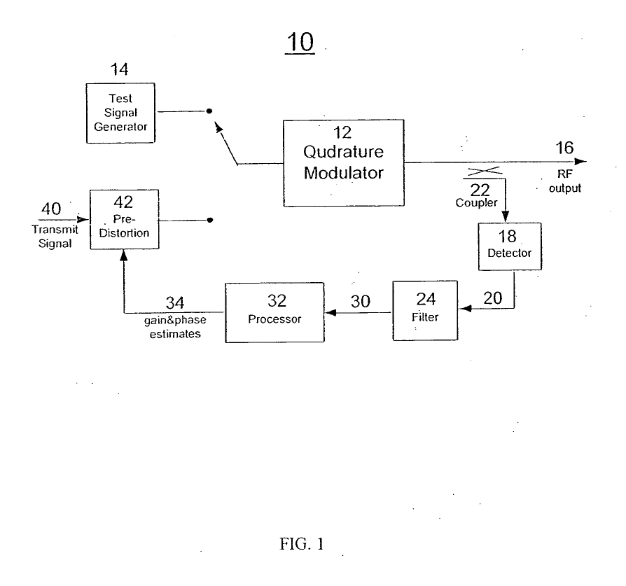

In FIG. 1, a quadrature modulator 12 receives as input test signals from a test signal generator 14, specifically sine waveforms with specific amplitude and phase, resulting in a specific output signal 16 at the quadrature modulator output. The quadrature modulator amplitude and phase imbalances distort this signal as compared with an ideal quadrature modulator. This distortion is equivalent to the generation of additional spectral components whose frequency, amplitude, and phase are functions of the modulator imbalance values. A sample of the output signal is coupled through an RF coupler 22 into a detector 18, which performs a non-linear operation that generates inter-modulation products between the various spectral components of the output signal, including a component at 2fᵢ, where fᵢ is the frequency of the input sine waveform. A detector output 20 is processed in a follow-up band-pass filter 24, which extracts the component at 2fᵢ, while rejecting the unwanted components. A filter output 30 is then input to a processor 32, preferably a digital processor, which computes estimates 34 of the gain and phase imbalance values. In other embodiments, filter 24 can be implemented as part of processor 32.

In normal transmit operation, an input signal 40 is passed through a pre-distortion device 42 that performs a pre-distortion transformation on the signal, which compensates the imbalance effects of the quadrature modulator. Computed estimates 34 are used to program pre-distortion device 42. Methods to design and program compensation devices such as device 42 are well known in the art.

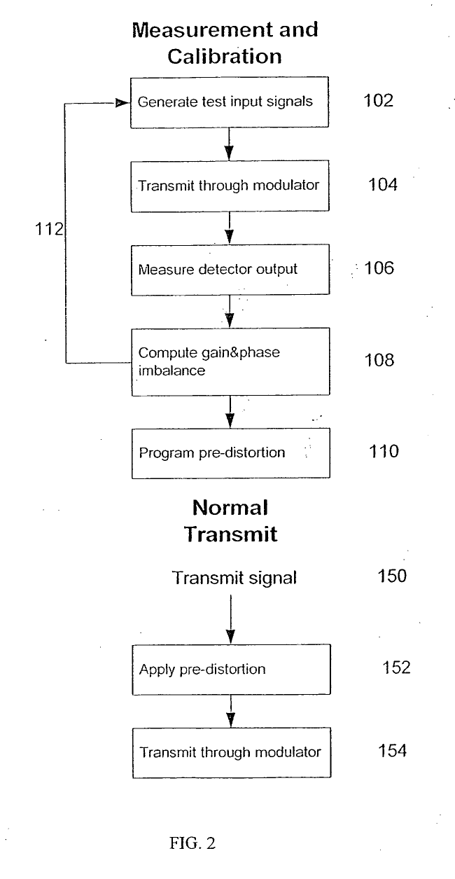

FIG. 2 shows a general block diagram of the method of the present invention. The measurement and calibration phase consists of the following steps, which are performed in sequence in order to evaluate first the gain imbalance terms and then repeated in order to evaluate the phase imbalance terms.

Signal generator 14 in FIG. 1 in a generating step 102 provides a test input signal. The test signals are then transmitted through quadrature modulator 12 to produce an output signal 16 that includes gain and phase distortion in a test signal transmission step 104. Detector 18 then detects signal 16 in a detection step 106 in which the detector output is also measured. Processor 32 then performs a gain and phase imbalance computing step 108, using the detector measurement. First, an estimate of gain imbalance is computed in an iterative way as shown by the arrow 112, by modifying the test input and repeating steps 102, 104 and 106 until the measured output reaches a predetermined (reference) value. Finally, a programming step 110 is carried out in processor 32, which programs the pre-distortion device to compensate for the gain imbalance effect. A similar sequence is carried out for compensating the phase imbalance effect.

Following the measurement and calibration stage, the transmitter is switched to a “normal” transmit operational mode. As shown in FIG. 2, the following steps are then performed: a pre-distortion transformation 152 is applied on a transmit signal 150 by pre-distortion device 42. The pre-distorted signal is then transmitted through quadrature modulator 12 in a transmitting step 154. The pre-distorted signal incurs existing gain and phase imbalances, however due to the pre-distortion, the net effect is almost an “ideal” quadrature modulated signal.

Quadrature Modulator

To better understand the method, a short discussion of the quadrature modulator operation and the effect of gain and phase imbalances is presented below.

An ideal quadrature modulator implements the following mathematical operation on a pair of input signals I(t) and Q(t):

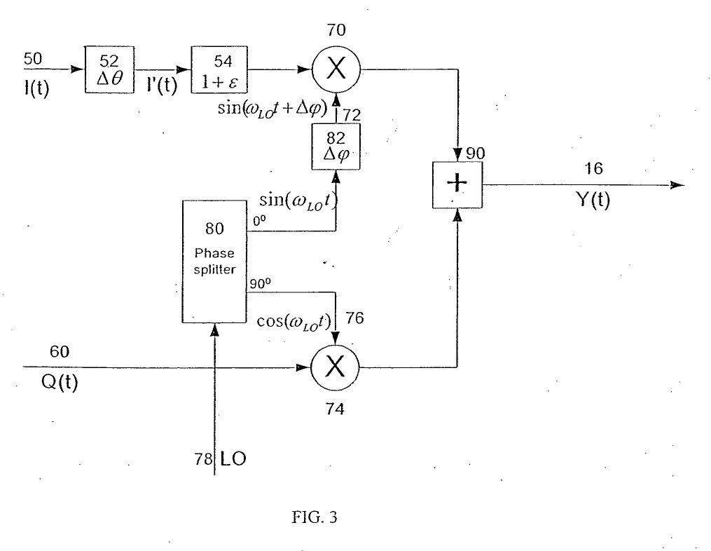

Y(t)=I(t) sin (ω_{LO}t)+Q(t) cos (ω_{LO}t) (1)

where I(t) and Q(t) are the base-band input signals and ω_{LO}=2πf_{LO} is the local oscillator (LO) radial frequency (rad/sec). The operation of a “practical” quadrature modulator that experiences gain and phase imbalances is shown in FIG. 3. The modulator has two input ports, one denoted I, or “in-phase” port 50, and the other Q or “quadrature” port 60. The corresponding base-band input signals incur gain and phase imbalances. Without any loss of generality, we can represent all imbalance effects as occurring in the path of the I signal. A block 52 represents the relative phase shift Δθ between the I and Q paths, while a block 54 represents the amplitude gain imbalance ratio 1+ε between the I and Q paths. The values ε and Δθ may be frequency dependent, i.e. function of input signal frequency fᵢ.

The I signal (distorted due to gain and phase imbalances) is input to the base-band input of a first mixer 70 while a first local oscillator signal 72 at frequency f_{LO} is input to the first mixer LO port. As is well known, a mixer such as mixer 70 effectively performs a multiplication between both input signals, thus frequency up-converting the input base-band signal. The Q signal is input to a second mixer 74, with a second local oscillator signal 76 also at frequency f_{LO} at the second mixer LO port, thus frequency up-converting the Q input base-band signal. The phase relation between the two up-converted signals is dependent on the relative phase between the two local oscillator signals. Local oscillator signals 72 and 76 are generated from a common input signal 78 by passing the input signal through a phase splitter device 80 having the property that its two outputs are 90° phase shifted (orthogonal) one with respect to the other. A phase error block 82 represents a phase error Δφ of this shifting, or, equivalently, an orthogonality phase imbalance Δφ between the two local oscillator signals. Here too, without any loss of generality, we can assume the orthogonality phase error is on the I path. A combining network 90 adds the output of the two mixers into quadrature modulator output 16. Below, the following notation is used:

The quadrature modulator output, including gain and phase (both base-band and orthogonality) imbalance is:

Y(t)=(1+ε)I′(t, Δθ) sin (ω_{LO}t+Δφ)+Q(t) cos (ω_{LO}t) (2)

and I′(t, Δθ) represents the phase shifted (by Δθ) transformation of the input I(t). When we deal with sine/cosine waveforms, then for I(t)=A cos (ωᵢt+θ) we have I′(t, Δθ)=A cos (ωᵢt+θ+Δθ). So:

I(t)=A cos (ωᵢt+θ)

Q(t)=B cos (ωᵢt)

and

Y(t)=(1+ε)A cos (ωᵢt+θ+Δθ) sin (ω_{LO}t+Δφ)+B cos (ωᵢt) cos (ω_{LO}t) (3)

It is well known that this modulated waveform can be put in a form:

Y(t)=S_{L} cos [(ω_{LO}−ωᵢ)t+ψ_{L})+S_{U} cos [(ω_{LO}+ωᵢ)t+ψ_{U}) (4)

showing that the quadrature modulator output for I and Q sine like inputs consists of two sideband carriers, one below the LO frequency at f_{LO}−fᵢ, and the other above it at f_{LO}+fᵢ. The amplitude and phase of these sidebands is related to the input amplitude and phase, as well as to the values of modulator imbalance. As shown below in the detailed method derivation, we preferably select specific values for the I and Q input amplitude and phase, in order to derive a simple dependency on the imbalance terms. Meanwhile, let us look at an interesting example:

### EXAMPLE

I(t), Q(t) sine/cosine waveforms with equal amplitude and frequency, but shifted by 90 degrees one with respect to the other, e.g.:

I(t)=A cos (ωᵢt−90°)=A sin (ωᵢt)

Q(t)=A cos (ωᵢt)

Ignoring the modulator imbalance we get:

Y(t)=A sin (ωᵢt) sin (ω_{LO}t)+A cos (ωᵢt) cos (ω_{LO}t)=A cos [(ω_{LO}−ωᵢ)t] (5)

i.e. the output contains a single sideband carrier at frequency f_{LO}−fᵢ=(ω_{LO}−ωᵢ)/2π. Now, for the same sine inputs waveforms, we compute the effect of gain and phase imbalances:

Y(t)=A(1+ε) sin (ωᵢt+Δε) sin (ω_{LO}t+Δφ)+A cos (ωᵢt) cos (ω_{LO}t) (6)

By standard trigonometric manipulation we can show that:

Y(t)=S_{L} cos [(ω_{LO}−ωᵢ)t+ψ_{L})+S_{U} cos [(ω_{LO}+ωᵢ)t+ψ_{U}) (7)

where:

$$\begin{matrix}{S}_{L} = A \sqrt{( 1 + ϵ ) {cos}^{2} ( \frac{Δ ϕ - Δ θ}{2} ) + {ϵ}^{2} / 4} & ( 8 ) \\ = \sim A ( 1 + ϵ / 2 ) & \\ {S}_{U} = A \sqrt{( 1 + ϵ ) {sin}^{2} ( \frac{Δ ϕ + Δ θ}{2} ) + {ϵ}^{2} / 4} & ( 9 ) \\ = \sim A [ ϵ / 2 + ( Δ ϕ + Δ θ ) / 2 ] & \end{matrix}$$

and where the approximations hold for sufficiently small values of the imbalance terms.

This expression shows that with gain and phase imbalances, we get a small component at the image frequency f_{LO}+fᵢ with amplitude proportional to the imbalance terms (in addition to the main term at f_{LO}−fᵢ whose amplitude is only slightly changed due to the gain imbalance).

Detector

The output signal (16, FIG. 1) of the quadrature modulator is coupled via a coupler (22 in FIG. 1) into a detector (18 in FIG. 1). The detector performs a nonlinear transformation on its input (signal 16). which can be approximated (square law detector) by:

Vₒᵤₜ=K₁Vᵢₙ²

where Vᵢₙ is the input, Vₒᵤₜ is the output and K₁ is a proportionality factor. It is well known that when input Vᵢₙ contains more than one carrier, the output will contain inter-modulation terms. Proper filtering (filter 24 of FIG. 1) allows selection of a desired term. For I and Q sine inputs we get:

Vᵢₙ=K₂Y(t)=K₂[S_{L} cos [(ω_{LO}−ωᵢ)t+ψ_{L})+S_{U} cos [(ω_{LO}+ωᵢ)t+ψ_{U})] (10)

The filter extracts the term at 2fᵢ while rejecting the unwanted terms. That is, while the modulator output has components at f_{LO}−fᵢ and f_{LO}+fᵢ, the detected output has components at 2fᵢ due to a non-linear effect. Then, the only relevant term (after filtering), Z, is a beat component between the two sub-carriers at a frequency equal to the frequency difference between the two sub-carriers, or equivalently at twice the base-band input frequency, and with an amplitude S_{D} proportional to the product of their amplitudes, i.e.:

Z=S_{D} cos (2ωᵢt+ψ)=k S_{U}S_{L} cos (2ωᵢt+ψ) (11)

where k is a proportionality factor and ψ is a phase tern (of no interest). Substituting in the above equation the values for the example above (eqn. 8 and 9). S_{D} is proportional to the imbalance terms, i.e.

S_{D}˜=kA²(1+ε/2)[ε/2+(Δθ+Δφ)/2]˜=K[ε/2+(Δθ+Δφ)/2] (12)

and where the approximations hold for sufficiently small imbalance terms. The non-linear transformation function of a “practical” detector may deviate from the above simple function (square law). As it will be shown in the detailed derivation for the gain and phase imbalance measurements, the proposed method is insensitive to the knowledge of the exact description of the detector transformation function.

Method Implementation

The method of the present invention includes two main stages:

Stage I: evaluate the gain imbalance term ε and apply the resulting compensation.

Stage II: evaluate the phase imbalance terms Δθ and Δφ and apply the resulting compensation.

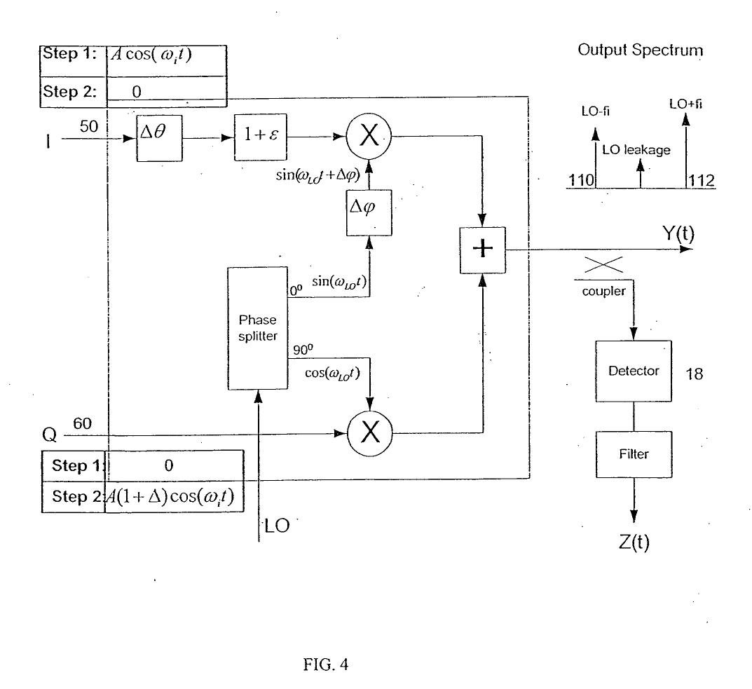

Stage I—Gain Imbalance: FIG. 4 shows the signal flow for the gain imbalance measurement. To evaluate the gain imbalance between the I and Q base-band paths we transmit in step 1 (as shown in more detail below) a test signal on I input port (henceforth “I input”) 50 with a zero signal on a Q input port (henceforth “Q input”) 60, and measure the resulting (first) signal amplitude at the filtered detector 18 output (this first amplitude will be used as a reference value in the next step). The experiment is repeated with the inputs interchanged (“step 2”, see below), that is a test signal on Q input 60 and zero signal on I input 50, measuring the resulting (second) signal amplitude at the detector output. The amplitude of the Q input test signal (step 2) is varied (up and down in small incremental steps) until the resulting signal amplitude at the detector output equals the reference value of step 1. This method enables the measurement of gain imbalance independent of the amount of phase imbalance. The gain imbalance is corrected by proper scaling of the I or Q inputs.

Stage I—Detailed Procedure

Step 1:

Transmit the following signals:

I₁(t)=A cos (ωᵢt) (13)

Q₁(t)=0

Then

Y₁(t)=A(1+ε) cos (ωᵢt+Δθ) sin (ω_{LO}t+Δφ)

The signal spectrum of Y₁(t) consists of two sub-carriers at f_{LO}−fᵢ 110 and f_{LO}+fᵢ 112, with almost equal amplitudes (equal when gain balance). The filtered detector output (i.e. the term at frequency 2fᵢ) equals to:

Z₁(t)=kA²(1+ε)² cos (2ωᵢt+ψ₁) (14)

where k is a proportionality factor and ψ₁ a phase term of no interest. Subscript “1” refers to parameters of step 1.

Step 2:

Repeat the experiment while interchanging between I and Q test signals, that is transmit:

I₂(t)=0 (15)

Q₂(t)=A(1+Δ) cos (ωᵢt)

where Δ is a control variable of the Q input amplitude. Then:

Y₂(t)=A(1+Δ) cos (ωᵢt) cos (ω_{LO}t)

It is easily shown that the filtered detector output (i.e. the term at frequency 2fᵢ) equals

Z₂(t)=kA²(1+Δ)² cos (2ωᵢt+ψ₂) (16)

where k is a proportionality factor and ψ₂ a phase term of no interest. Subscript “2” refers to parameters of step 2. Under the assumption of a square-law detector and with Δ=0, the gain imbalance can be easily derived from the ratio of the amplitudes of Z₁ and Z₂ (equations 14 and 16) as amp(Z₁)/amp(Z₂)=(1+ε)². Instead of computing this ratio, we use the measured amplitude of Z₁ (of step 1) as a reference value, and iteratively modify the input amplitude in step 2 (up and down in small incremental steps via the control variable Δ) until the resulting amplitude of Z₂ equals the reference value. Let \overline{Δ} be the value of Δ for which this equality occurs. Then:

ε=\overline{Δ}

The equalization of the amplitudes via this iterative procedure enables solving for the gain imbalance term without any assumption on the exact form of the non-linear transformation function of a “practical” detector. Following the measurement and evaluation of the gain imbalance term, the signals transmitted on the I and Q ports are properly scaled to compensate for this effect.

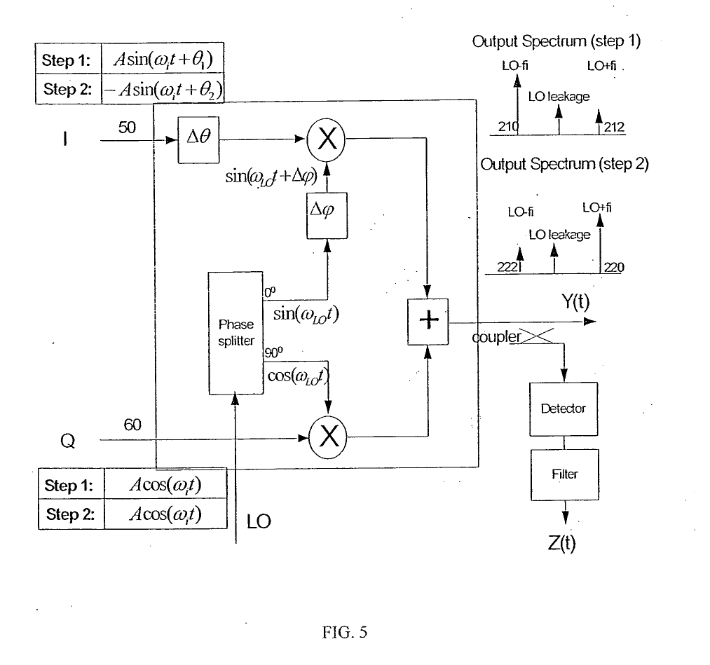

Stage II—Phase Imbalance: FIG. 5 shows the signal flow for the phase imbalance measurement. To evaluate the phase imbalance between the I and Q base-band paths, as well as the orthogonality phase imbalance in the LO path, we transmit in step 1 a sine test signal on I input 50 with a cosine (i.e. −90° phase relation) signal on Q input 60, and measure the resulting (first) signal amplitude at the filtered detector 18 output. The input test signal is such that ideally (with no phase imbalance) we should get a single sideband carrier 210. Due to the phase imbalance, we get also a small sideband component 212 at the image frequency. After detector 18, we get a component at frequency 2fᵢ, whose amplitude is proportional to the phase imbalance. The procedure is repeated in step 2 with new test inputs 50 and 60 selected such that the phase relation between inputs I and Q is (nominally) +90°. In this case we get a a main sideband carrier 222 and a small sideband component 220 at the image frequency, however their frequency positions are reversed with respect to step 1. We measure the resulting (second) signal amplitude at the detector output. Based on the two measurements we could solve for both base-band phase imbalance Δθ, and orthogonality (local oscillator) phase imbalance Δφ. However, this would require a-priori calibration of the detector and knowledge of its non-linear transformation function. In the detailed description below we prefer a variation of the above procedure (suitable for “practical” detectors) where, instead of measuring the 2fᵢ signal amplitude at detector output (requiring calibrated measurement), we shift the Q input with respect to the I input by a (known) control phase θ till we cancel the 2fᵢ term. The θ value for which cancellation occurs is used to solve for Δθ and Δφ.

We assume that gain imbalance measurements have been performed, and that the signals transmitted on the I and Q ports are properly scaled. However, phase imbalance measurements can also be performed while there is still a small residual gain imbalance.

Stage II—Detailed Procedure

Step I

Transmit two sine waveforms with equal amplitude and frequency, but phase-shifted with respect to the other by 90°−θ₁ where θ₁ is a control (tuning) phase variable:

I₁(t)=A cos (ωᵢt−90°+θ₁)=A sin (ωᵢt+θ₁) (17)

Q₁(t)=A cos (ωᵢt)

Assuming gain balance (equivalently, gain imbalance has been pre-compensated) we get

Y₁(t)=A sin (ωᵢt+θ₁+Δθ) sin (ω_{LO}t+Δφ)+A cos (ωᵢt) cos (ω_{LO}t) (18)

By standard trigonometric manipulation we can show that:

Y₁(t)=S_{L1} cos [(ω_{LO}−ωᵢ)t+ψ_{L1})+S_{U1} cos [(ω_{LO}+ωᵢ)t+ψ_{U1}) (19)

where:

S_{L1}=A cos [(θ₁+Δθ−Δφ)/2]=˜A

S_{U1}=A|sin [(θ₁+Δθ+Δφ)/2]|=˜A|(θ₁+Δθ+Δφ)/2|

and the filtered detector output (i.e. the term at frequency 2fᵢ) equals:

Z₁(t)=kA²|sin [(θ₁+Δθ+Δφ)/2]|cos (2ωᵢt+ψ₁) (20)

where k is a proportionality factor and ψ₁ is a phase term of no interest. Let \overline{θ₁} be the value of θ₁ which cancels the beat component Z₁.

\overline{θ₁}=−(Δθ+Δφ)

\overline{θ₁} is evaluated by varying θ₁ in small steps (within a range) till we cancel the beat component Z₁. Note that in this step we found the combined base-band Δθ and local oscillator Δφ phase imbalance. For some quadrature modulators, Δθ is negligible, in which case Δφ=˜(−1)\overline{θ₁}. However when this assumption is not valid, an additional step is required to solve individually for Δθ and Δφ, as explained below in step 2. When the measurement is noisy or there is a residual gain imbalance, \overline{θ₁} is the value that minimizes (not cancels) Z₁.

Step 2:

We repeat the experiment but use the inputs:

I₂(t)=A cos (ωᵢt+90°+θ₂)=−A sin (ωᵢt+θ₂) (21)

Q₂(t)=A cos (ωᵢt)

where θ₂ is a control (tuning) phase variable.

Y₂(t)=−A sin (ωᵢt+θ₂+Δθ) sin (ω_{LO}t+Δφ)+A cos (ωᵢt) cos (ω_{LO}t) (22)

By standard trigonometric manipulation we get:

Y₂(t)=S_{L2} cos [(ω_{LO}−ωᵢ)t+ψ_{L2})+S_{U2} cos [(ω_{LO}+ωᵢ)t+ψ_{U2}) (23)

where:

S_{L2}=A|sin [(θ₂+Δθ−Δφ)/2]|=˜A|(θ₂+Δθ−Δφ)/2|

S_{U2}=A cos [(θ₂+Δθ+Δφ)/2]=˜A

ψ_{L2} and ψ_{U2} are phase terms of no interest. As expected, this signal has its large component at frequency f_{LO}+fᵢ while in Step 1 we got it at f_{LO}−fᵢ. Similar to Step 1, the filtered detector output (i.e. the term at frequency 2fᵢ) equals:

Z₂(t)=kA²|sin [(θ₂+Δθ−Δφ)/2]|cos (2ωᵢt+ψ₂) (24)

where k is a proportionality factor and ψ₂ a phase term of no interest. Let \overline{θ₂} be the value of θ₂ which cancels the beat component Z₂.

\overline{θ₂}=˜Δθ+Δφ

Solving the two equations results in:

Δθ=−(\overline{θ₁}+\overline{θ₂})/2

Δθ=(−\overline{θ₁}+\overline{θ₂})/2

Cancellation of the beat components Z₁ and Z₂ via this iterative procedure enables solving for the phase imbalance terms without any assumption on the knowledge of the exact form of the non-linear transformation function of the detector. The resulting phase imbalance terms are used to generate a transformation on the input signals thus compensating for the quadrature modulator base-band and orthogonality phase imbalance. The compensation, equivalently pre-distortion methods are known and not repeated here.

In summary, the proposed method uses in its preferred embodiment test input signals with controlled amplitude and phase. It is well known that the gain and phase imbalances reflect on the spectral contents of the output, requiring a complex narrow band receiver to extract this information. However, in an innovative way and in contrast with prior art techniques, the proposed method uses a sequence of test signals at base-band frequency fᵢ together with a detector to analyze the amplitude of the detector output at frequency 2fᵢ. This output term is proportional to the gain and phase imbalances and, by controlling the test signals it is possible to compute an estimate of the gain and phase imbalances. The test inputs are selected such that the value of the term at frequency 2fᵢ has sufficient immunity from measurement and detector generated noise, thus generating accurate results. In addition, the gain and phase imbalance measurements can be performed at several values N of the input frequency fᵢ, thus mapping their frequency dependence. For single carrier modulation, we typically perform compensation by using an average (or mid-frequency) value of the gain and phase imbalances, however, for multi-carrier modulation, such as Orthogonal Frequency Division Multiplexing (OFDM), frequency dependent compensation based on the 2fᵢ component (N) can be applied individually for each carrier. For clarity, the sequence of measurement and compensation at each frequency fᵢ is carried out as explained above.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made.

What is claimed is:

1. A method for calibrating a quadrature modulator having an I input and a Q input for inputting base-band I(t) and Q(t) signals, the modulator used to transmit quadrature modulated signals, comprising
a. estimating in sequence values of modulator gain imbalances and of modulator phase imbalances while the modulator is operational, said estimating including:
i. inputting at least one test signal at a base-band frequency fᵢ to the modulator to generate detected output signals having a term at frequency 2fᵢ, first in said gain imbalance estimation, then in said phase imbalance estimation, and
ii. computing said gain and phase imbalances based on said 2fᵢ term of said detected output signals, and
b. in normal transmit operation, compensating first for said gain and then for said phase imbalances to obtain an essentially ideal quadrature modulated signal, said compensating including:
iii. inputting a transmission signal to the modulator, and
iv. based on said computed gain and phase imbalances, applying a pre-distortion transformation on said input transmission signal.

2. The method of claim 1, wherein said inputting includes:
a. for said gain imbalance, inputting in a first step a cosine waveform at the I input, and a zero waveform at the Q input as given by eqn. 13, and in a second step a zero waveform at the I input and a cosine waveform at the Q input as given by eqn. 15, and,
b. for said phase imbalance, inputting in a first step at the I and Q inputs two sine waveforms of equal amplitude and frequency but shifted by −90°+θ₁ as given by eqn. 17, and, optionally, inputting in a second step two sine waveforms of equal amplitude and frequency but shifted by +90°+θ₂ as given by eqn. 21.

3. The method of claim 1, wherein said computing of said gain imbalance is based on an iterative operation that includes modifying said test signals and repeating said measurement of said detected output signal terms at frequency 2fᵢ until reaching a reference value of said output signal.

4. The method of claim 1, wherein said computing of said phase imbalances includes computing separately a base-band phase imbalance Δθ and a local oscillator orthogonality phase imbalance Δφ, using said inputting and an iterative operation that includes modifying said test signals and repeating said measurement of said detector output signals until effectively cancelling said detected output signal terms at frequency 2fᵢ.

5. The method of claim 3, wherein said reference value is the result of the first measurement of the detected output amplitude at frequency 2fᵢ as generated by a first test signal.

6. The method of claim 1, wherein said inputting at least one test signal at a base-band frequency fᵢ includes inputting a plurality N of test signals, each at a different base-band frequency fᵢ(N), and wherein said applying a pre-distortion transformation on said input transmission signal includes applying a frequency-dependent pre-distortion transformation.
